(19) United States
(12) Patent Application Publication
(10) Pub. No.: US 2015/0347941 A1
(43) Pub. Date: Dec. 3, 2015

(54) METHOD AND SYSTEM FOR COMPLEX DYNAMIC SUPPLY CHAIN SYSTEMS MODELING MANAGEMENT AND OPTIMIZATION

(71) Applicant: General Electric Company, Schenectady, NY (US)

(72) Inventors: Walter Charles Yund, IV, Ballston Spa, NY (US); Farshid Attarian, South Egremount, MA (US); Patricia Denise MacKenzie, Clifton Park, NY (US); Joseph James Salvo, Schenectady, NY (US); Richard Paul Messmer, Niskayuna, NY (US); Peter Koudal, Niskayuna, NY (US)

(73) Assignee: General Electric Company, Schenectady, NY (US)

(21) Appl. No.: 14/291,593

(22) Filed: May 30, 2014

(51) Int. Cl. G06Q 10/06

(52) U.S. Cl. CPC G06Q 10/06312

(57) ABSTRACT

A system includes a processor and a non-transitory computer-readable medium. The computer-readable medium includes instructions that when executed by the processor perform a method. The method comprises receiving component data from a plurality of actors and determining a pre-optimization validation of a supply chain optimization model. The supply chain optimization model is created using a linear optimization technique when the pre-optimization validation indicates a valid supply chain optimization model where creating comprises executing an optimization algorithm. Results associated with a supply chain systems model are displayed.

### BACKGROUND

One type of business process management system relates to organizing supplies used by a business entity (e.g., a corporation) for manufacturing and delivering goods and/or services. The organization and management of supplies is often referred to as a supply chain. A supply chain comprises a system of organizations, people, activities, information, and resources associated with the manufacture and delivery of a product or service from supplier to customer. Because a supply chain can encompass a complex set of resources from around the globe, a manager of a supply chain has limited ability to optimize the supply chain and a limited ability to respond to issues associated with allocation of resources. A manager's failure to respond to risks and opportunities to drive cost reduction and revenue growth can have significant impact on an organization's ability to deliver a good or service and remain profitable.

For example, in a global economy, a supply chain manager may face challenges relating to (i) allocating material globally such as figuring out where to place inventory so it is best located for the next time period's demand and (ii) defects in the supply chain which may not be immediately noticeable and may also be tough to validate. Therefore, a workflow that integrates data, processes, models and people for automated supply chain modeling and optimization is desirable.

### SUMMARY

In some embodiments, a method for a supply chain systems model includes receiving first component data from a first actor and receiving second component data from a second actor. A pre-optimization validation of a supply chain optimization model is determined and the supply chain optimization model is created using a linear optimization technique when the pre-optimization validation determines a valid supply chain optimization model. Creating a supply chain optimization model includes executing an optimization algorithm. The results associated with a supply chain systems model that comprises the supply chain optimization model are displayed.

In some embodiments, a non-transitory computer-readable medium includes instructions that, when executed by a processor, perform a method for a supply chain systems model. The method includes receiving first component data from a first actor and receiving second component data from a second actor. A pre-optimization validation of a supply chain optimization model is determined and the supply chain optimization model is created using a linear optimization technique when the pre-optimization validation determines a valid supply chain optimization model. Creating a supply chain optimization model includes executing an optimization algorithm. The results associated with the supply chain systems model that comprises the supply chain optimization model are displayed.

In some embodiments, a system includes a processor and a non-transitory computer-readable medium that comprises instructions. When the instructions are executed by the processor, the system receives first component data from a first actor and receives second component data from a second actor. A pre-optimization validation of a supply chain optimization model is determined and the supply chain optimization model is created using a linear optimization technique when the pre-optimization validation determines a valid supply chain optimization model. Creating a supply chain optimization model includes executing an optimization algorithm. The results associated with the supply chain systems model that comprises the supply chain optimization model are displayed.

### BRIEF DESCRIPTION OF THE DRAWINGS

FIG. 1 is a flow diagram of an operation according to some embodiments.

FIG. 2 is a representation of a supply chain according to some embodiments.

FIG. 3 is a block diagram of a system according to some embodiments.

FIG. 4 is a block diagram of a system according to some embodiments.

FIG. 5 is a supply chain according to some embodiments.

FIG. 6 is a supply chain systems model display screen according to some embodiments.

FIG. 7 illustrates a supply chain systems model according to some embodiments.

### DESCRIPTION

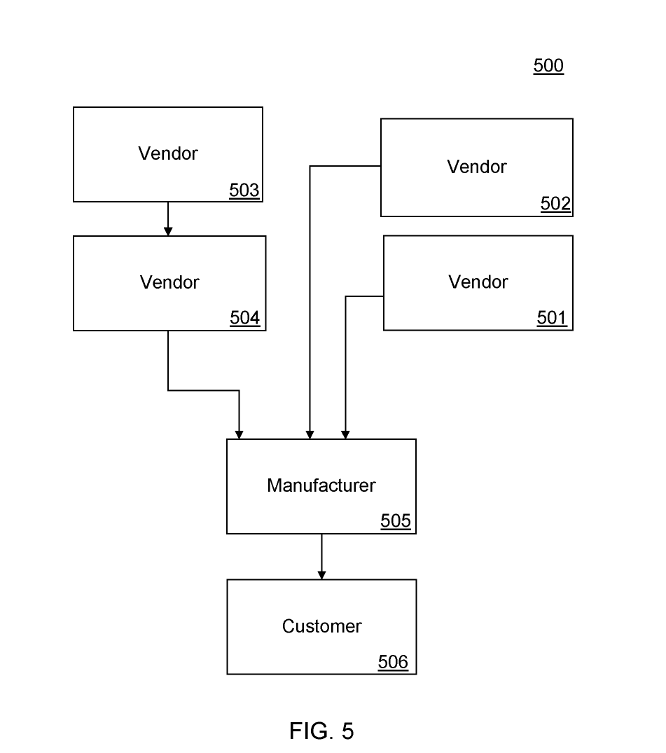

Some of the present embodiments relate to a method and system for integrating business processes, data, supply chain models, and people to deliver a real-time supply chain systems modeling and optimization system. A supply chain will be described in further detail with respect to FIG. 5. The present embodiments may relate to the integration of a business process model with a supply chain optimization model to provide a dynamically reconfigurable supply chain systems model which addresses the limited ability that supply chain managers currently have to optimize allocation and respond to risk and opportunities to drive cost reduction and revenue growth.

For illustrative purposes, and to aid in understanding features of the specification, an example will be introduced. This example is not intended to limit the scope of the claims. For example, an international corporation may manufacture and sell wind turbines. Each wind turbine may comprise blades, a rotor, a tower and a shaft. For purposes of this example, each of these components may be manufactured by a different supplier and thus blades may be supplied from supplier A, rotors from supplier B, towers from supplier C and shafts from supplier D. Failure of any of the aforementioned suppliers may prevent wind turbines from being built and delivered in a timely manner.

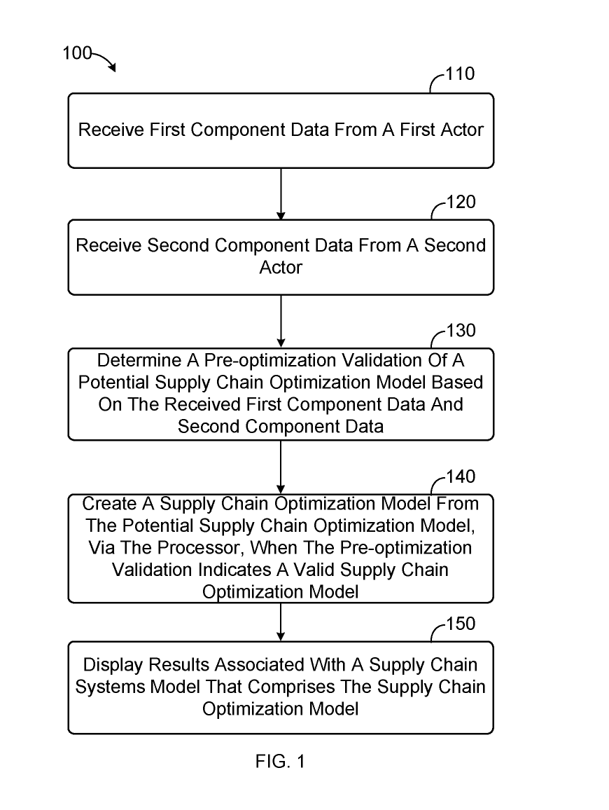

Referring now to FIG. 1, an embodiment of a flow diagram of a process 100 is illustrated. In some embodiments, various hardware elements (e.g., a processor) of a system perform the process 100. The process 100 and other processes mentioned herein may be embodied in processor-executable program code read from one or more non-transitory computer-readable media, such as a floppy disk, a CD-ROM, a DVD-ROM, a Flash drive, and a magnetic tape, and may be stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

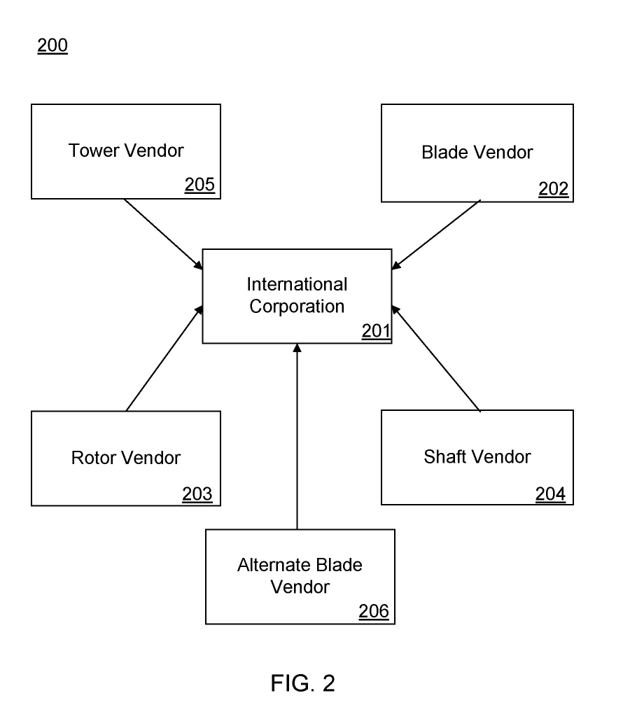

Initially, at 110, first component data from a first actor is received. An actor may comprise, but is not limited to, a vendor/supplier, a sourcing leader, a commodity leader, a sourcing executive, a finance analyst, a model analyst, a business analyst, a computer system or an attorney. Component data may comprise data associated with the goods that a supplier produces. For example, component data may relate to a supplier's production capabilities such as, but not limited to, a number of units a supplier can produce in a given time period, information about a supplier's delivery mechanism, facilities' capabilities, government restrictions imposed on the supplier such as, but not limited, to a workforce demographic or other legal requirement (e.g., a certain percentage of local citizens must be employed by the supplier), costs per unit of production, cost per unit for delivery, etc. The first and second component data may be received from the first actor and second actor respectively. For example, the first and second component data may be based on current conditions associated with the first actor and second actor respectively. Continuing with the above example, and now referring to FIG. 2, an embodiment of a supply chain 200 is illustrated. An international corporation 201 may receive component data from a plurality of actors that supply blades, rotors, towers and shafts. For example, the international corporation 201 may receive component data from a blade vendor 202, a rotor vendor 203, a shaft vendor 204 and a tower vendor 205. In some embodiments, the international corporation 201 may receive component data from alternative actors that also supply blades, rotors, towers and shafts so that multiple actors may be used for comparison when creating a supply chain optimization model. For example, an alternate blade vendor 206 may also supply component data to the international corporation 201.

Referring back to FIG. 1, at 120 second component data from a second actor is received. The second component data may comprise data associated with the goods that a supplier produces. For example, component data may relate to a supplier's production capabilities such as, but not limited to, a number of units a supplier can produce in a given time period, information about a supplier's delivery mechanism, facilities' capabilities, government restrictions imposed on the supplier such as, but not limited, to a workforce demographic or other legal requirement (e.g., a certain percentage of local citizens must be employed by the supplier), costs per unit of production, cost per unit for delivery, etc. While the present example describes first and second component data, additional received data components may used in other examples, such as third, fourth, n-th component data, etc.

Historical data regarding the plurality of vendors may also be received from a local repository (e.g., a database) that stores historic data associated with the plurality of actors. The received historic data may comprise supply chain systems models that were created based on an actor's past performance related to support, production and/or delivery of goods and/or services. The historical data in one example is used with the component data from the actors.

At 130, a pre-optimization validation of a potential supply chain optimization model is determined based on the received component data. In some embodiments, the determination may be based on a combination of the received component data and historic data. The determination may be based on weighting the historical data and the received component data. In this regard, current supply chain optimization models may be based on an actor's past performance as well as an anticipated future performance using current component data. Future performance may comprise anticipated component data that is based on historical and present component data. The pre-optimization validation may use historical data as an input into the model as well as information gathered from disparate data sources. The pre-optimization validation may be used to prevent conflicts within the information received from disparate data sources (e.g., component data from multiple sources). For example, one data source may indicate that a product was already shipped and a second data source may indicate that the same product was not shipped. This conflict may be determined by the pre-optimization validation and flagged so that the conflict may be resolved prior to a supply chain optimization model being created. As a further example, a first received component data may indicate a quantity of 1000 units whereas another component data associated with the same purchase order may indicate a quantity of 100,000 units.

The pre-optimization validation may comprise a determination that a supply chain optimization model is a valid model or is a not a valid model. Determining a valid model may indicate that the pre-optimization validation has determined that there are no conflicts with the data received from the first actor and the second actor. Determining that a model is not valid may indicate that a conflict exists in the data supplied from the first actor and the second actor. If a model is determined to be invalid, a user may be notified of discrepancies determined by the pre-optimization validation.

The pre-optimization validation may also be associated with a supplier Line Of Balance (“LOB”) process. A LOB process may be associated with a repetitive process that exists within a contract's work scope and the manufacturing and assembly of parts in the factory. A LOB may comprise a management control process for collecting, measuring and presenting facts relating to time, cost and accomplishment which may all be measured against a specific plan. Based on the received historical data and the received component data the supplier LOB should always remain positive based on scenarios forecast by the pre-optimization validation. If the supplier LOB remains positive based on scenarios forecast by the pre-optimization validation, then the supply chain optimization model may be validated.

Continuing with the above example, a pre-optimization validation may be performed based on the received component data from the blade vendor 202, the rotor vendor 203, the shaft vendor 204 and the tower vendor 205. The pre-optimization validation may validate that indicated received quantities indicated as being shipped match with indicated amounts of goods being received.

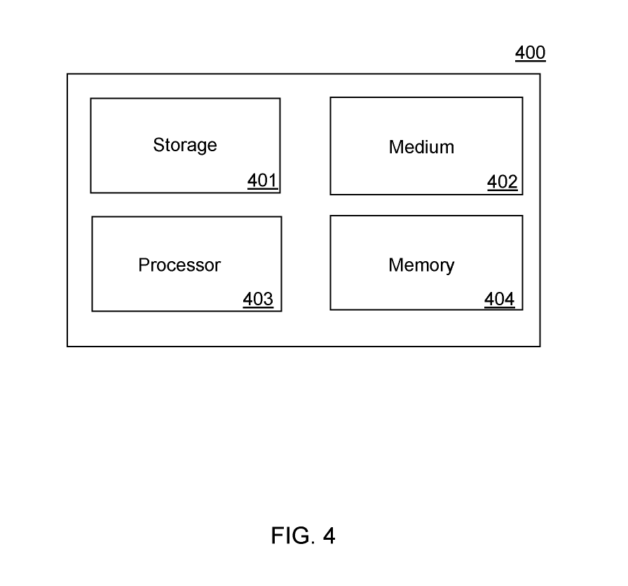

When the pre-optimization validation determines a valid supply chain optimization model, at 140 the supply chain optimization model may be created. The supply chain optimization model may be created by a processor such as the processor described with respect to FIG. 4. The potential supply chain optimization model may be created by utilizing a linear optimization technique or other techniques that may be used to create a supply chain optimization model. The linear optimization technique may comprise a mathematical optimization technique to create a model based on reducing the cost of operations while maintaining an acceptable level of production and/or service, and where profit is determined based on a given set of alternatives. The supply chain optimization model may also be based on carryovers (e.g., parts and/or product that were not previously used or sold) and unmet demand for products (e.g., an amount of product that could have been sold if the product has been produced). For the current component data, each of these data (e.g., carryovers and unmet demand) may be stored in the database and used for future supply chain systems models.

In another embodiment, during the process of creating supply chain optimization model, an optimized interpolation automatically resolves issues associated with unpopulated data. In this embodiment, the optimized interpolation may use a current model and/or previous models to determine missing historical data. For example, if two products are indicated as arriving (e.g., the shipment has arrived) but the model has no record of shipping dates for the two products, the pre-optimization validation may use historical data to determine when the two products were shipped (e.g., fill in the missing data). Furthermore, the optimized interpolation may be used to include complex rules. For example, if four instances of product x are needed to make two instances of product y, then this formula may be added to the optimized interpolation to ensure proper quantities are received from an actor.

In some embodiments, the supply chain optimization model may take into account that there is a high probability that each of the actors will timely deliver their respective goods or services. In some embodiments, an output of creating a LOB may illustrate a process, a status, a background, timing and phasing of the project activities, and thus the LOB may provide management with measuring tools to (i) compare actual progress with an objective plan, (ii) examine any deviations from the objective plan (as well as gauging their degree of severity with respect to the remainder of the project), (iii) indicate areas where appropriate corrective action is required and/or (iv) forecast future performance. The supply chain optimization model may also take into account the extra costs that will occur when an actor is not timely and potentially misses a delivery date. The supply chain optimization model may take into account constraints such as if a supplier can't build his goods, the supplier can't ship his goods and there may be financial repercussions associated with missing a delivery date. Unlike manual methods, the present embodiments may automatically facilitate (e.g., a technical effect) the optimization of supply chain models as various actors change component data and/or when there is a change in the various actors.

Continuing with the above-example, a supply chain optimization model is created based on a linear optimization technique and this model is then saved into a database where each element of the supply chain optimization model may be viewable. Results associated with the supply chain systems model are displayed at 150.

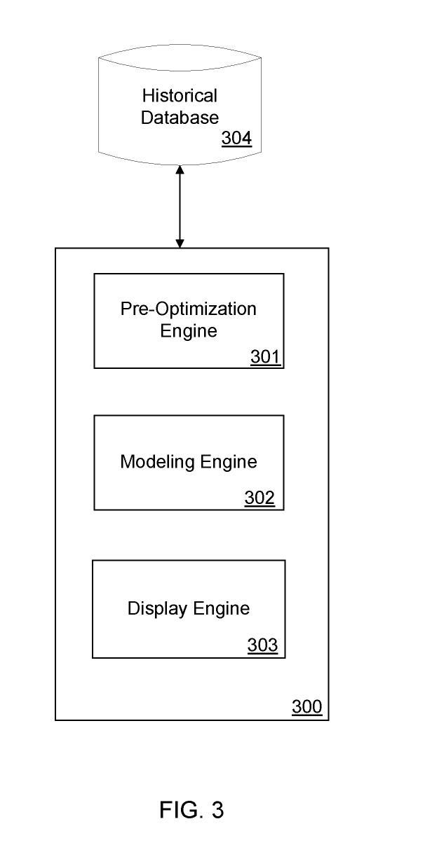

Now referring to FIG. 3, an embodiment of a system 300 is illustrated. The system 300 may relate to supply chain optimization modeling. The system 300 may comprise a pre-optimization engine 301, a modeling engine 302 and a display engine 303 that are in communication with a historical database 304.

The pre-optimization engine 301 may receive a plurality of data from a plurality of actors as well as historical data associated with the plurality of actors. The historical data may be retrieved from the historical database 304. Furthermore, the pre-optimization engine 301 may further base its validation of a supply chain optimization model on a user that approved prior historical models (e.g., user identification). Each historical supply chain optimization model may be associated with a user that approved that model and this information may be stored in a repository. Therefore, if a user associated with a model is considered a risk (e.g., the user approved supply chain optimization models that have failed), prior models approved by the risky user may not be used. Furthermore, users that are known to have approved accurate models may have models associated with their user identification receive a higher priority of use. Once the pre-optimization engine 301 validates a model based on the received data, the modeling engine 302 may create a supply chain optimization model by utilizing a linear optimization technique. For example, a linear optimization technique may comprise a mathematical method for determining a way to achieve a best outcome in a given mathematical model for a list of requirements represented as linear relationships.

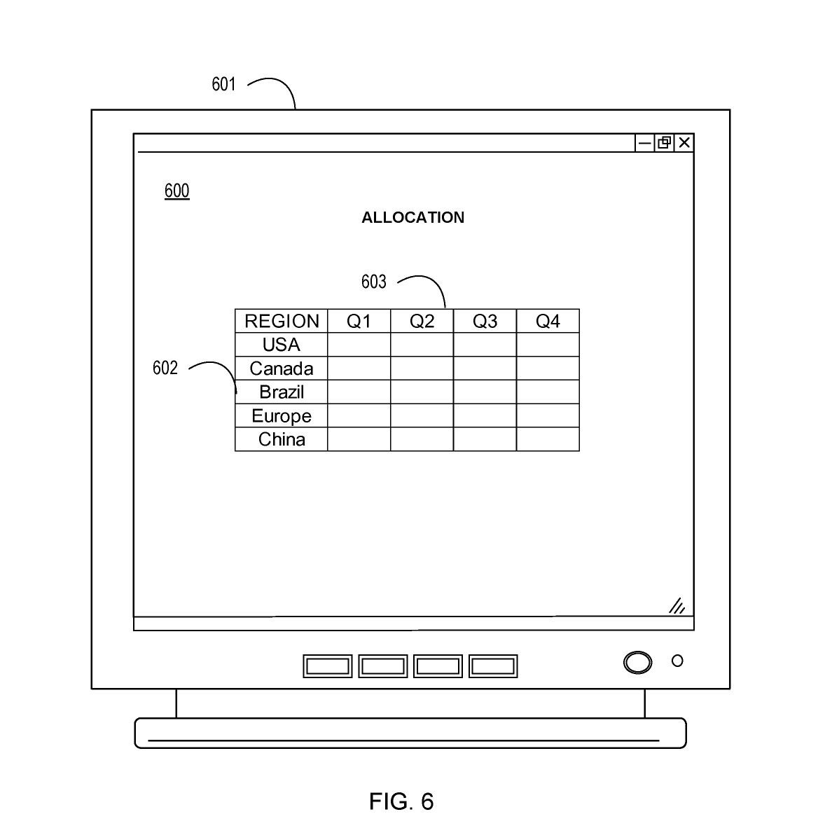

The display engine 303 may provide multiple display options for a user to evaluate and examine supply chain optimization models and their associated results. For example, one display option may comprise an executive view that can display quarterly results associated with the supply chain optimization model. The executive view may also illustrate which vendors are delinquent in their deliveries of goods and/or services. The executive view may illustrate results from the model in chronological order. FIG. 6 illustrates an example of an executive view 600 being displayed on a display device 601. As illustrated, FIG. 6 comprises a display that is broken up by region 602 and by quarterly periods 603. In the illustrated embodiment, the executive view displays a product allocation by quarter for each region that the product is sold.

In some embodiments, the display engine 303 may also provide a release model view that allows a user to examine an unreleased supply chain optimization model. If the user is comfortable with the results of the unreleased supply chain optimization model, the supply chain optimization model may be published. In some embodiments, the published supply chain optimization model will be associated with a user identification of the user that released the supply chain optimization model.

In some embodiments, the display engine 303 may provide a comparison view that allows a user to compare a plurality of supply chain optimization models. The comparison view may allow a user to vary elements of a supply chain optimization model to determine how changes may affect the supply chain optimization model. For example, a user may change factors that affect production such as, but not limited to, a change in pricing of goods or the end product, a change in profitability, a delivery date change and/or a change in demand.

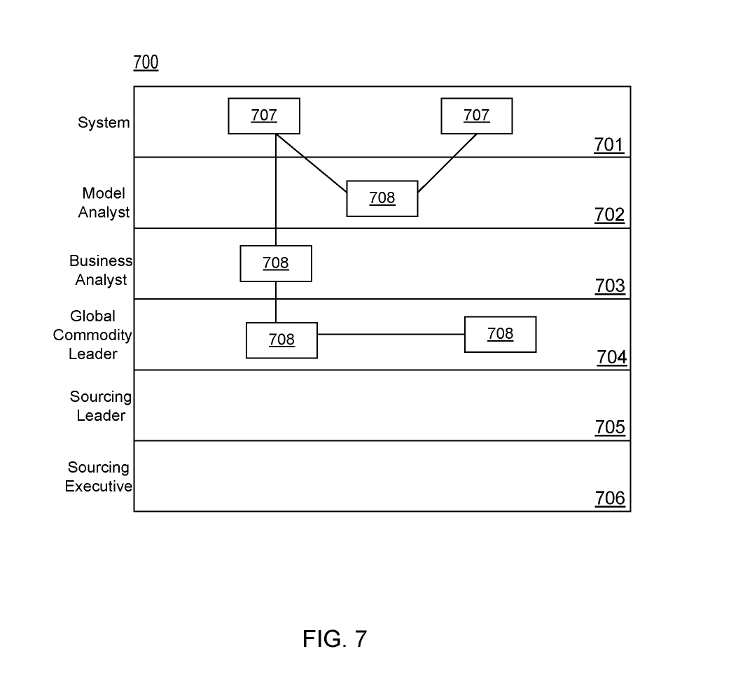

The aforementioned embodiments integrate business processes, data, supply chain optimization models, and people to deliver a real-time supply chain systems modeling system. A supply chain systems model may comprise a supply chain optimization model, as described previously, which is inserted into a business process model. Some advantages of the present embodiments comprise speed and accuracy over conventional systems, executive views for risk mitigation, model and data versioning, user role management, and asset utilization, logistics, LOB, inventory and/or total cost. For example, and now referring to FIG. 7, an embodiment of a supply chain systems model 700 is illustrated. The supply chain systems model 700 comprises both a business process model that illustrates a plurality of actor lanes 701/702/703/704/705/706 where each actor lane 701/702/703/704/705/706 is associated with a respective actor as well as supply chain optimization models 707. Each actor lane 701/702/703/704/705/706 may provide a view in which an analyst may move or reassign business process elements 708 associated with the plurality of actors. In some embodiments, a business process element 708 associated with a first actor may be moved to lane associated with a second actor and vice versa.

Continuing with the above example, a first actor that supplies data for blades stops supplying data for blades and now supplies data for rotors and a second actor that supplied business rules, for example, may now supply demand data. In this example, a supply chain systems model may be dynamically reconfigured in response to the changes associated with the actors and the system 700 may automatically create (e.g., calculate) a new model based on new data associated with the first actor and the second actor, if it exists, as well as historical data associated with the first actor and the second actor.

Furthermore, the system 700 may upload data from a stored location when a new model is to be created, remind the plurality of actors associated with the plurality of actor lanes 701/702/703/704/705/706 to input data when required, and send reminders that a new supply chain systems model is available for review. By combining a business process model with a pre-optimization validation, the present embodiments may integrate a business process model with a supply chain optimization model to provide a dynamically reconfigurable supply chain systems model. The supply chain optimization model may be integrated into the business process model, from a supply chain systems model.

Now referring to FIG. 4, an embodiment of an apparatus 400 is illustrated. In some embodiments, the apparatus 400 may be associated with a supply chain systems modeling system.

The apparatus 400 may comprise a storage device 401, a medium 402, a processor 403, and a memory 404. According to some embodiments, the apparatus 400 may further comprise a digital display port, such as a port adapted to be coupled to a digital computer monitor, television, portable display screen, or the like.

The medium 402 may comprise any computer-readable medium that may store processor-executable instructions to be executed by the processor 403. For example, the medium 402 may comprise a non-transitory tangible medium such as, but not limited to, a compact disk, a digital video disk, flash memory, optical storage, random access memory, read only memory, or magnetic media.

A program may be stored on the medium 402 in a compressed, uncompiled and/or encrypted format. The program may furthermore include other program elements, such as an operating system, a database management system, and/or device drivers used by the processor 403 to interface with peripheral devices.

The processor 403 may include or otherwise be associated with dedicated registers, stacks, queues, etc. that are used to execute program code and/or one or more of these elements may be shared there between. In some embodiments, the processor 403 may comprise an integrated circuit. In some embodiments, the processor 403 may comprise circuitry to perform a method such as, but not limited to, the method described with respect to FIG. 1.

The processor 403 communicates with the storage device 401. The storage device 401 may comprise any appropriate information storage device, including combinations of magnetic storage devices (e.g., a hard disk drive), optical storage devices, flash drives, and/or semiconductor memory devices. The storage device 401 stores a program for controlling the processor 403. The processor 403 performs instructions of the program, and thereby operates in accordance with any of the embodiments described herein.

The main memory 404 may comprise any type of memory for storing data, such as, but not limited to, a flash driver, a Secure Digital (SD) card, a micro SD card, a Single Data Rate Random Access Memory (SDR-RAM), a Double Data Rate Random Access Memory (DDR-RAM), or a Programmable Read Only Memory (PROM). The main memory 404 may comprise a plurality of memory modules.

As used herein, information may be “received” by or “transmitted” to, for example: (i) the apparatus 400 from another device; or (ii) a software application or module within the apparatus 400 from another software application, module, or any other source.

In some embodiments, the storage device 401 stores a database (e.g., including information associated with supply chain optimization models and users associated with the supply chain optimization models). Note that the database described herein is only an example, and additional and/or different information may be stored therein. Moreover, various databases might be split or combined in accordance with any of the embodiments described herein. In some embodiments, an external database may be used.

Now referring to FIG. 5, an embodiment of a supply chain 500 is illustrated. The supply chain 500 may comprise a plurality of actors such as actor 501, actor 502, actor 503, and actors 504. The actors 501-504 supply material to manufacturer 505. Manufacturer 505 builds a product that is sold to a customer 506. As illustrated in FIG. 5, some vendors may supply material to other vendors. For example, vendor 503 may supply material to vendor 504 which uses the material received from vendor 503 to create material that is sent to the manufacturer (e.g., a chain).

Embodiments described herein are solely for the purpose of illustration. A person of ordinary skill in the relevant art may recognize other embodiments may be practiced with modifications and alterations to that described above.

What is claimed is:

1. A method associated with a supply chain systems model, the method comprising:
receiving first component data from a first actor;
receiving second component data from a second actor;
determining, via a processor, a pre-optimization validation of a potential supply chain optimization model based on the received first component data and second component data;
creating a supply chain optimization model from the potential supply chain optimization model using a linear optimization technique, via the processor, when the pre-optimization validation indicates a valid supply chain optimization model; and
displaying results associated with a supply chain systems model that comprises the supply chain optimization model.

2. The method of claim 1, wherein determining the pre-optimization validation determines if a data conflict exists, the data conflict based on the information from the first component data and the second component data.

3. The method of claim 2, wherein the pre-optimization validation is based on historical data associated with the first actor and the second actor.

4. The method of claim 3, wherein the historical data comprises past supply chain systems models associated with the first actor and the second actor.

5. The method of claim 1, further comprising:
receiving the first component data from the second actor;
receiving the second component data from the first actor; and
automatically reconfiguring the supply chain optimization model based on the first component data being received from the second actor and the second component data being received from the first actor.

6. The method of claim 1, wherein the supply chain systems optimization is created by performing an optimization algorithm that comprises a linear optimization algorithm.

7. A non-transitory computer-readable medium comprising instructions that when executed by a processor perform a method, the method comprising:
receiving first component data from a first actor;
receiving second component data from a second actor;
determining, via a processor, a pre-optimization validation of a potential supply chain optimization model based on the received first component data and second component data;
creating a supply chain optimization model from the potential supply chain optimization model using a linear optimization technique, via the processor, when the pre-optimization validation indicates a valid supply chain optimization model; and
displaying results associated with the a supply chain systems model that comprises the supply chain optimization model.

8. The medium of claim 7, wherein determining the pre-optimization validation determines if a data conflict exists, the data conflict based on the information from the first component data and the second component data.

9. The medium of claim 8, wherein the pre-optimization validation is based on historical data associated with the first actor and the second actor.

10. The medium of claim 9, wherein the historical data comprises past supply chain systems models associated with the first actor and the second actor.

11. The medium of claim 7, further comprising:
receiving the first component data from the second actor;
receiving the second component data from the first actor; and
automatically reconfiguring the supply chain optimization model based on the first component data being received from the second actor and the second component data being received from the first actor.

12. The medium of claim 7, wherein the supply optimization systems model is created by performing an optimization algorithm that comprises a linear optimization algorithm.

13. The medium of claim 7, wherein creating comprises executing an optimization algorithm.

14. A system comprising:
a processor;
a non-transitory computer-readable medium comprising instructions that when executed by the processor perform a method, the method comprising:
receiving first component data from a first actor;
receiving second component data from a second actor;
determining, via the processor, a pre-optimization validation of a potential supply chain optimization model based on the received first component data and second component data;
creating a supply chain optimization model from the potential supply chain optimization model using a linear optimization technique, via the processor, when the pre-optimization validation indicates a valid supply chain optimization model; and
displaying results associated with a supply chain systems model that comprises the supply chain optimization model.

15. The system of claim 14, wherein determining the pre-optimization validation determines if a data conflict exists, the data conflict based on the information from the first component data and the second component data.

16. The system of claim 15, wherein the pre-optimization validation is based on historical data associated with the first actor and the second actor.

17. The system of claim 16, wherein the historical data comprises past supply chain systems models associated with the first actor and the second actor.

18. The system of claim 14, further comprising:
receiving the first component data from the second actor;
receiving the second component data from the first actor; and
automatically reconfiguring the supply chain optimization model based on the first component data being received from the second actor and the second component data being received from the first actor.

19. The system of claim 14, wherein the supply chain optimization model is created by performing an optimization algorithm that comprises a linear optimization algorithm associated with carry over and unmet demand.

20. The system of claim 14, wherein creating comprises executing an optimization algorithm.
